(19) United States
(12) Patent Application Publication
(10) Pub. No.: US 2019/0310658 A1
(43) Pub. Date: Oct. 10, 2019

(54) UNMANNED AERIAL VEHICLE

(71) Applicant: SZ DJI TECHNOLOGY CO., LTD., Shenzhen (CN)

(72) Inventor: Chengwei ZHU, Shenzhen (CN)

(21) Appl. No.: 16/445,796

(22) Filed: Jun. 19, 2019

Related U.S. Application Data
(63) Continuation of application No. PCT/CN2016/111490, filed on Dec. 22, 2016.

(51) Int. Cl. G05D 1/06; G05D 1/04; B64C 39/02

(52) U.S. Cl. CPC G05D 1/0607; G05D 1/042; B64C 2201/127; B64C 2201/123; B64C 39/024

(57) ABSTRACT

A method for controlling an unmanned aerial vehicle (UAV) comprises receiving a position of a target in an image, obtaining a flight height of the UAV relative to a ground, and controlling a flight of the UAV according at least to the position of the target in the image and the flight height.

### CROSS-REFERENCE TO RELATED APPLICATION

This application is a continuation of International Application No. PCT/CN2016/111490, filed on Dec. 22, 2016, the entire content of which is incorporated herein by reference.

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The present disclosure relates to unmanned aerial vehicle (UAV) technology and, more particularly, to a UAV having an autonomous flight function.

### BACKGROUND

Conventional unmanned aerial vehicles (UAVs) need to be controlled by a remote controller. That is, a manual control manner is generally used to operate the UAVs. If the UAVs need to realize an autonomous flight without using the remote controller, technologies that convert tasks or goals into a set of control instructions need to be performed to guide or control the UAVs to reach a designated area or continue to fly.

### SUMMARY

In accordance with the disclosure, there is provided a method for controlling an unmanned aerial vehicle (UAV) including receiving a position of a target in an image, obtaining a flight height of the UAV relative to the ground, and controlling a flight of the UAV according at least to the position of the target in the image and the flight height.

Also in accordance with the disclosure, there is provided an unmanned aerial vehicle (UAV) including a sensor and a processor. The sensor is configured to obtain a flight height of the UAV relative to a ground. The processor is configured to receive a position of a target in an image and control a flight of the UAV according at least to the position of the target in the image and the flight height.

### BRIEF DESCRIPTION OF THE DRAWINGS

In order to provide a clearer illustration of various embodiments of the present disclosure or technical solutions in conventional technology, the drawings used in the description of the disclosed embodiments are briefly described below. The following drawings are merely embodiments of the present disclosure. Other drawings may be obtained based on the disclosed drawings by those skilled in the art without creative efforts.

FIG. 1 is a schematic structural diagram of an unmanned aerial vehicle (UAV) according to the disclosure.

FIG. 2 is a schematic structural diagram of a bottom of a UAV according to the disclosure.

FIG. 3 is a schematic block diagram of a UAV according to the disclosure.

FIG. 4 is a flowchart of a UAV control method according to the disclosure.

FIG. 5 schematically shows a UAV computing a position of a target according to the disclosure.

FIG. 6 schematically shows a UAV flight path according to the disclosure.

FIG. 7 schematically shows another UAV flight path according to the disclosure.

### DETAILED DESCRIPTION OF THE EMBODIMENTS

Technical solutions of the present disclosure will be described with reference to the drawings. It will be appreciated that the described embodiments are some rather than all of the embodiments of the present disclosure. Other embodiments conceived by those having ordinary skills in the art on the basis of the described embodiments without inventive efforts should fall within the scope of the present disclosure.

The terms “first,” “second,” or the like in the specification, claims, and the drawings of the present disclosure are merely used to distinguish similar elements, and are not intended to describe a specified order or a sequence. The involved elements may be interchangeable in any suitable situation, such that the elements having the same attribute can be distinguished in the description of embodiments of the present disclosure. In addition, the terms “including,” “comprising,” and variations thereof herein are open, non-limiting terminologies, which are meant to encompass a series of steps of processes and methods, or a series of units of systems, apparatus, or devices listed thereafter and equivalents thereof as well as additional steps of the processes and methods or units of the systems, apparatus, or devices that are not listed.

Exemplary embodiments will be described with reference to the accompanying drawings. In the situation where the technical solutions described in the embodiments are not conflicting, they can be combined.

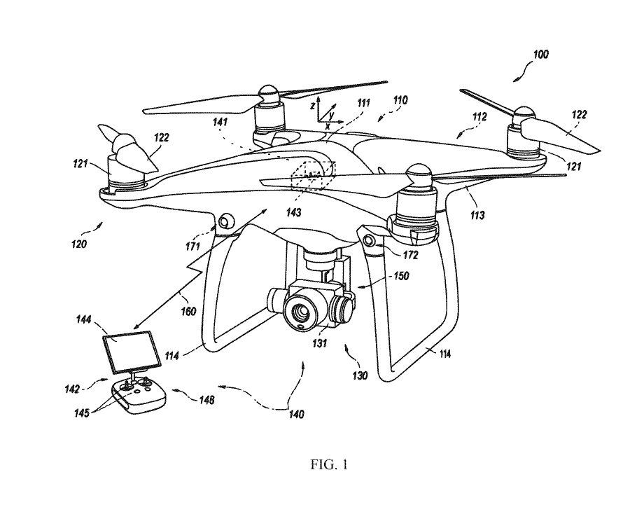

FIG. 1 is a schematic structural diagram of an unmanned aerial vehicle (UAV) 100 consistent with the disclosure. The UAV 100 includes a fuselage 110. The fuselage 110 includes a central portion 111 and at least one outer portion 112. In some embodiments, as shown in FIG. 1, the fuselage 110 includes four outer portions 112 (e.g., four arms 113). The four outer portions 112 are extending from the central portion 111. In some embodiments, the fuselage 110 may include any number of outer portions 112 (e.g., 6, 8, or the like). In some embodiments, each outer portion 112 may carry a propulsion system 120 and the propulsion system 120 can drive the UAV 100 to move (e.g., climb, land, move horizontally, or the like). For example, each arm 113 can carry a corresponding motor 121 and the motor 121 can drive a corresponding propeller 122 to rotate. The UAV 100 can control any one set of the motors 121 and the corresponding propellers 122 without being affected by the other sets of the motors 121 and the corresponding propellers 122.

The fuselage 110 carries a load 130, such as an imaging device 131. In some embodiments, the imaging device 131 may include a camera configured, for example, to photograph images, videos, or the like surrounding the UAV. The camera can sense light having various wavelengths, including, but not limited to, visible light, ultraviolet light, infrared light, or any combination thereof. In some embodiments, the load 130 may include another kind of sensor. In some embodiments, the load 130 is connected to the fuselage 110 via a gimbal 150, such that the load 130 can move relative to the fuselage 110. For example, when the load 130 includes the imaging device 131, the imaging device 131 can move relative to the fuselage 110 to photograph images, videos, or the like surrounding the UAV. As shown in FIG. 1, landing gear 114 supports the UAV 100 to protect the load 130 when the UAV 100 is landing on the ground.

In some embodiments, the UAV 100 includes a control system 140 and the control system 140 includes components arranged at the UAV 100 and components separate from the UAV 100. For example, the control system 140 includes a first controller 141 arranged at the UAV 100, and a second controller 142 separate from the UAV 100 and connected to the first controller 141 via a communication link 160 (e.g., a wireless link). The first controller 141 may include at least one processor, a memory, and an onboard computer-readable medium 143. The onboard computer-readable medium 143 can store program instructions configured to control actions of the UAV 100. The actions of the UAV 100 include, but are not limited to, operating the propulsion system 120, operating the imaging device 131, controlling the UAV to perform automatic landing, or the like. The onboard computer-readable medium 143 may also be configured to store state information of the UAV 100, such as a height, a speed, a position, a preset reference height, or the like. The second controller 142 may include at least one processor, a memory, an offboard computer-readable medium, and at least one input-output device 148, such as a display device 144 and a control device 145. An operator of the UAV 100 can remotely control the UAV 100 through the control device 145 and receive feedback information from the UAV 100 through the display device 144 and/or another device. In some embodiments, the UAV 100 can operate autonomously. In this situation, the second controller 142 can be omitted or the operator of the UAV 100 can rewrite flight functions of the UAV 100 via the second controller 142. The onboard computer-readable medium 143 may be moved out of the UAV 100. The offboard computer readable medium may be moved out of the second controller 142.

In some embodiments, the UAV 100 includes two front-facing cameras 171 and 172. The front-facing cameras 171 and 172 can sense light having various wavelengths (e.g., visible light, infrared light, or ultraviolet light) and can be configured to photograph images or videos surrounding the UAV. In some embodiments, the UAV 100 can include at least one sensor arranged at a bottom of the UAV 100.

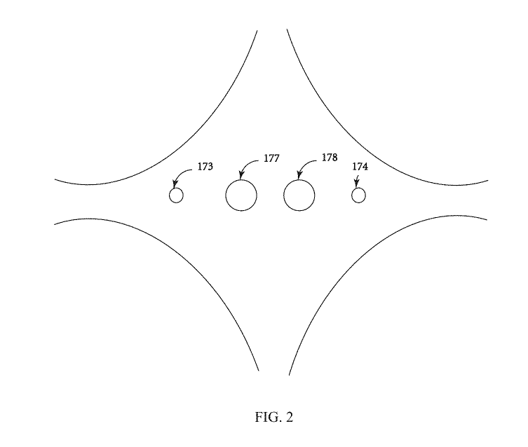

FIG. 2 is a schematic structural diagram of a bottom of the UAV 100 consistent with the disclosure. As shown in FIG. 2, the UAV 100 includes two down-view cameras 173 and 174 arranged at the bottom of the fuselage 100. In addition, the UAV 100 also includes two ultrasonic sensors 177 and 178 arranged at the bottom of the fuselage 110. The ultrasonic sensors 177 and 178 can detect and/or monitor an object and the ground under the bottom of the UAV 100 and can measure a distance of the UAV 100 from the object or the ground by sending and receiving ultrasonic waves.

In some embodiments, the UAV 100 may include an inertial measurement unit (IMU), an infrared sensor, a microwave sensor, a temperature sensor, a proximity sensor, a three-dimensional (3D) laser rangefinder, a 3D time-of-flight (TOF) sensor, or the like. The 3D laser rangefinder and the 3D TOF can detect a distance of the UAV 100 from an object or the ground below the UAV 100.

In some embodiments, the UAV 100 may receive input information from the input-output device 148. For example, a user can send a target to the UAV 100 through the input-output device 148. The UAV 100 can recognize a corresponding position of the target on the ground according to the target and the first controller can control the UAV 100 to fly to the corresponding position and hover over the corresponding position.

In some embodiments, the UAV 100 may receive input information from the input-output device 148. For example, the user can send the target to the UAV 100 through the input-output device 148. The UAV 100 can recognize the corresponding position of the target on the ground according to the target. The first controller can control the UAV 100 to fly to the preset reference height and fly at the preset reference height.

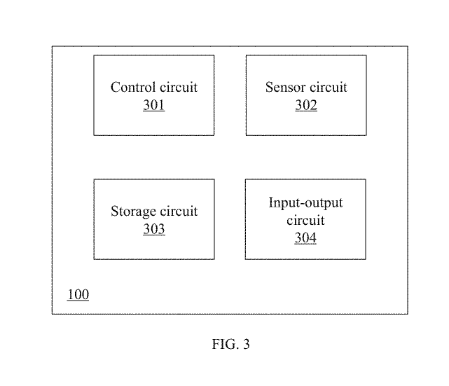

FIG. 3 is a schematic block diagram of the UAV 100 consistent with the disclosure. As shown in FIG. 3, the UAV 100 includes a control circuit 301, a sensor circuit 302, a storage circuit 303, and an input-output circuit 304.

The control circuit 301 can include at least one processor. The processor includes, but is not limited to, a microcontroller, a reduced instruction set computer (RISC), an application specific integrated circuit (ASIC), an application-specific instruction-set processor (ASIP), a central processing unit (CPU), a physics processing unit (PPU), a digital signal processor (DSP), a field programmable gate array (FPGA), or the like.

The sensor circuit 302 can include at least one sensor. The sensor includes, but is not limited to, a temperature sensor, an IMU, an accelerometer, an image sensor (e.g., a camera), an ultrasonic sensor, a TOF sensor, a microwave sensor, a proximity sensor, a 3D laser rangefinder, an infrared sensor, or the like.

In some embodiments, the IMU can be configured to measure attitude information of the UAV 100 (e.g., a pitch angle, a roll angle, a yaw angle, or the like). The IMU may include, but is not limited to, at least one accelerometer, gyroscope, magnetometer, or any combination thereof. The accelerometer can be configured to measure an acceleration of the UAV 100 to calculate a speed of the UAV 100.

The storage circuit 303 may include, but is not limited to, a read only memory (ROM), a random-access memory (RAM), a programmable read-only memory (PROM), an electronic erasable programmable read-only memory (EEPROM), or the like. The storage circuit 303 may include a non-transitory computer-readable medium that can store codes, logics, or instructions for performing at least one of the processes consistent with the disclosure. The control circuit 301 may perform at least one process individually or cooperatively according to the codes, logics, or instructions of the non-transitory computer-readable media described herein. The storage circuit 303 may be configured to store state information of the UAV 100, such as a height, a speed, a position, a preset reference height, or the like.

The input-output circuit 304 can be configured to output information or instructions to an external device. For example, the external device can receive an instruction sent by the input-output device 148 (as shown in FIG. 1), or an image photographed by the imaging device 131 (as shown in FIG. 1) can be sent to the input-output device 148.

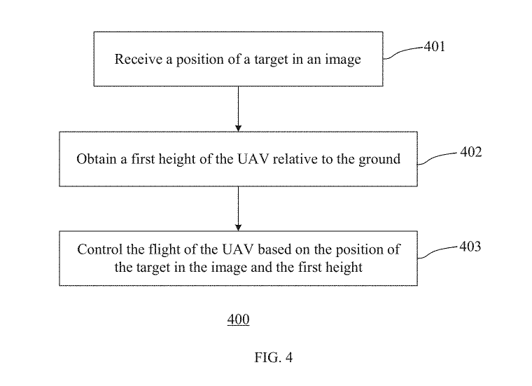

FIG. 4 is a flowchart of a UAV control method 400 consistent with the disclosure.

As shown in FIG. 4, at 401, a position of a target in an image is received.

In some embodiments, the user can select a flight mode through the input-output device 148, for example, by tapping a screen 550 to select the flight mode. The flight mode includes, but is not limited to, a guiding flight mode, a smart follow mode, an autonomous return mode, or the like.

In some embodiments, for the guiding flight mode, the user can click on any point on the screen 550 to determine the target. The input-output device 148 can send position information of the target to the UAV 500. The position information of the target can be used to control the flight of the UAV 500.

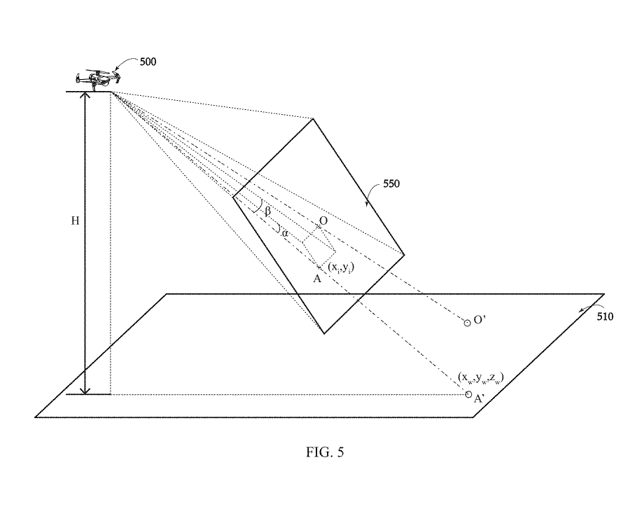

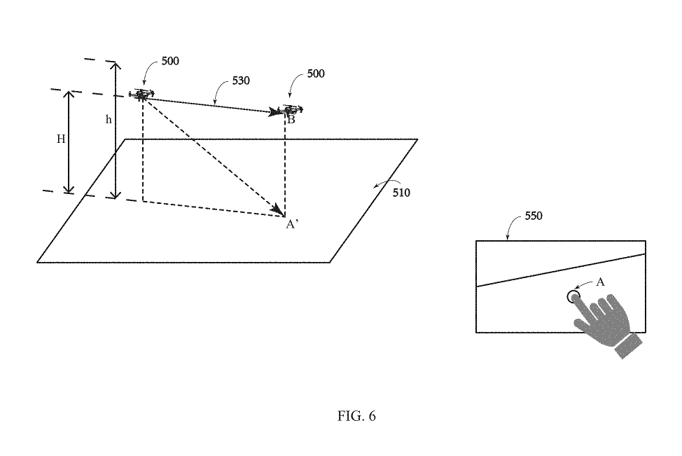

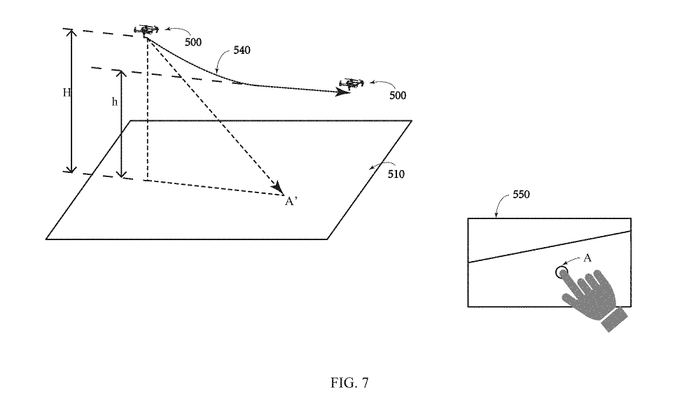

FIG. 5 schematically shows a UAV 500 computing a position of a target consistent with the disclosure. FIG. 6 schematically shows a UAV flight path consistent with the disclosure. FIG. 7 schematically shows another UAV flight path consistent with the disclosure. As shown in FIGS. 6 and 7, the user can select a target A on the screen 550. After the target A is selected, the input-output device 148 can calculate coordinates (x_{screen}, y_{screen}) of the target A on the screen 550. The input-output device 148 can further convert the coordinates on the screen 550 into coordinates (x_{rawimage}, y_{rawimage}) in a raw image of the camera. The input-output device 148 can also normalize the coordinates (x_{rawimage}, y_{rawimage}) in the raw image of the camera to (x_{percentage}, y_{percentage}), according to the following formula:

$$\{ \begin{matrix}{x}_{percentage} = \frac{{x}_{rawimage}}{ImageWidth} \\ {y}_{percentage} = \frac{{y}_{rawimage}}{ImageHeight}\end{matrix}$$

The coordinates (x_{percentage}, y_{percentage}) can be sent to the UAV 500 to calculate a spatial flight direction of the UAV 500.

At 402, a first height of the UAV relative to the ground is obtained.

As shown in FIGS. 6 and 7, the first height H of the UAV 500 relative to the ground can be obtained. The first height H is also referred to as a “flight height.”

In some embodiments, the UAV 500 may obtain the first height via at least one onboard sensor. The first height may be a current height of the UAV 500 with respect to the ground. The at least one sensor may include, but is not limited to, an ultrasonic sensor, a TOF sensor (e.g., a 3D TOF sensor), an infrared sensor, a microwave sensor, a proximity sensor, a 3D laser rangefinder, a barometer, a GPS module, or the like.

The first height H may be used to control the flight of the UAV 500. In some embodiments, when the first height H is less than a preset reference height h and the target A′ (the actual point in the real world that corresponds to the target A on the screen 550) is on the ground 510, the UAV 500 can fly horizontally at the first height H and hover directly above A′ (e.g., along a flight path 530). In some embodiments, when the first height H is greater than the preset reference height h, and the target A′ is on the ground 510, the UAV 500 can fly to the preset reference height h and then fly at the preset reference height h (e.g., along a flight path 540).

In some embodiments, when the first height H is smaller than the preset reference height h and the target A′ is on the ground, the UAV 500 can fly at any height and hover directly above A′.

At 403, the flight of the UAV is controlled based on the position of the target in the image and the first height.

In some embodiments, the processor can calculate the coordinates of A′ based on the position of the target A in the image.

As shown in FIG. 5, A′ is a corresponding point of A in the world coordinate system, the coordinates of a direction vector \vec{OA} are (x_{w}, y_{w}, z_{w}), D represents a depth, and z_{w}=D. (xᵢ, yᵢ) is the coordinates of A in a camera coordinate system and f is a focal length. Thus, the following relationship can be obtained:

$$\{ \begin{matrix}\frac{{x}_{w}}{{z}_{w}} = \frac{{x}_{i}}{f} \\ \frac{{y}_{w}}{{z}_{w }} = \frac{{y}_{i}}{f}\end{matrix}$$

The following formula is based on (x_{percentage}, y_{percentage}), (xᵢ, yᵢ), and a size of the image (ImageWidth, ImageHeight):

$$\{ \begin{matrix}{x}_{i} = ( {x}_{percentage} - 1 / 2 ) * ImageWidth \\ {y}_{i} = ( \frac{1}{2} - {y}_{percentage} ) * ImageHeight\end{matrix}$$

Based on the following relationship between the focal length and a field of view (FOV) of the image,

$$\{ \begin{matrix}f = \frac{ImageWidth}{2 tan ( {FOV}_{h} / 2 )} \\ f = \frac{ImageHeight}{2 tan ( {FOV}_{v} / 2 )}\end{matrix}$$

the following formula can be obtained:

$$\{ \begin{matrix}\frac{{x}_{i}}{f} = \frac{( {x}_{percentage} - \frac{1}{2} ) * ImageWidth}{\frac{ImageWidth}{2 tan ( \frac{{FOV}_{h}}{2} )}} = ( 2 * {x}_{percentage} - 1 ) * tan ( \frac{{FOV}_{h}}{2} ) \\ \frac{{y}_{i}}{f} = \frac{( \frac{1}{2} - {y}_{percentage} ) * ImageHeight}{\frac{ImageHeight}{2 tan ( \frac{{FOV}_{v}}{2} )}} = ( 1 - 2 * {y}_{percentage} ) * tan ( \frac{{FOV}_{v}}{2} )\end{matrix}$$

Thus, the following formula can be obtained:

$$\{ \begin{matrix}{x}_{w} = ( 2 * {x}_{percentage} - 1 ) * tan ( \frac{{FOV}_{h}}{2} ) * D \\ {y}_{w} = ( 1 - 2 * {y}_{percentage} ) * tan ( \frac{{FOV}_{v}}{2} ) * D \\ {z}_{w} = D\end{matrix}$$

It can be seen that the formula (x_{w}, y_{w}, z_{w}) contains an unknown value D. The direction vector (\vec{OA}) can be normalized to eliminate the unknown value D. Assume that D=1, and hence the direction vector (\vec{OA}) can be expressed as:

$$\{ \begin{matrix}{x}_{w} = ( 2 * {x}_{percentage} - 1 ) * tan ( \frac{{FOV}_{h}}{2} ) \\ {y}_{w} = ( 1 - 2 * {y}_{percentage} ) * tan ( \frac{{FOV}_{v}}{2} ) \\ {z}_{w} = 1\end{matrix}$$

The direction vector (\vec{OA}) can be further normalized to obtain:

$$\vec{OA} = ( \begin{matrix}\frac{{x}_{w}}{norm ( {x}_{w} , {y}_{w} , {z}_{w} )} \\ \frac{{y}_{w}}{norm ( {x}_{w} , {y}_{w} , {z}_{w} )} \\ \frac{{z}_{w}}{norm ( {x}_{w} , {y}_{w} , {z}_{w} )}\end{matrix} )$$

Therefore, the coordinates of the direction vector (\vec{OA}) can be obtained in the camera coordinate system.

The processor can calculate a direction vector \vec{OA}_{gim} corresponding to the direction vector \vec{OA} in a gimbal coordinate system using the following formula, according to the direction vector \vec{OA} and a rotation matrix R_{cam}^{gim}. R_{cam}^{gim} is the rotation matrix of the camera coordinate system to the gimbal coordinate system, where:

\vec{OA}_{gim}=R_{cam}^{gim}\vec{OA}

The processor can calculate the direction vector (\vec{O′A′}) corresponding to the direction vector \vec{OA}_{gim} in the world coordinate system using the following formula, according to the direction vector \vec{OA}_{gim} and a rotation matrix R_{gim}^{gnd}. R_{gim}^{gnd} is the rotation matrix of the gimbal coordinate system to the world coordinate system, where:

\vec{O′A′}=R_{gim}^{gnd}\vec{OA}_{gim}

Therefore, the processor can calculate the direction vector \vec{O′A′} according to the following formula:

\vec{O′A′}=R_{gim}^{gnd}R_{cam}^{gim}\vec{OA}

where,

R_{cam}^{gnd}=R_{gim}^{gnd}R_{cam}^{gim}

The processor can calculate R_{cam}^{gnd} according to the following formula, where R_{cam}^{gnd} is the rotation matrix of the camera coordinate system to the world coordinate system,

$${R}_{cam}^{gnd} = [ \begin{matrix}cos α cos γ - cos β sin α sin γ & - cos βcos γ sin α - cos αsin γ & sin α sin β \\ cos γ sin α + cos αcos β sin γ & cos α cos β cos γ - sin α sin γ & - cos α sin β \\ sin βsin γ & cos γ sin β & cos β\end{matrix} ]$$

where (α, β, γ) represent attitude angles of the gimbal (e.g., the pitch angle, the roll angle, the yaw angle, or the like).

In some embodiments, the processor can calculate the direction vector \vec{O′A′}_{gnd} (x_{gnd},y_{gnd},z_{gnd}) of the direction vector \vec{O′A′} with respect to the ground using the following formula, according to the direction vector \vec{O′A′}(x′, y′, z′) and the first height H.

$$\frac{{x}_{gnd}}{{x}^{′}} = \frac{{y}_{gnd}}{{y}^{′}} = \frac{{z}_{gnd}}{{z}^{′}}$$

where z_{gnd} is the first height H.

The processor can calculate the direction vector \vec{O′A′}_{origin}(x_{origin}, y_{origin}, z_{origin}) of the direction vector \vec{O′A′}_{gnd} with respect to a UAV taking-off point using the following formula, according to the direction vector \vec{O′A′}_{gnd} and the current position of the UAV (posₓ,pos_{y},pos_{z}).

$$\{ \begin{matrix}{x}_{origin} = {x}_{gnd} + {pos}_{x} \\ {y}_{origin} = {y}_{gnd} + {pos}_{y} \\ {z}_{origin} = {z}_{gnd} + {pos}_{z}\end{matrix}$$

In some embodiments, if the first height H is less than the preset reference height h, the processor can control the UAV to fly to A′ and hover above A′, according to the direction vector \vec{O′A′}_{origin}.

In some embodiments, the processor can calculate the coordinates of A′ according to \vec{O′A′}, and if the first height H is greater than the preset reference height h, the UAV can be controlled to fly to the preset reference height and fly at the preset reference height.

In some embodiments, if the UAV 500 detects that an orientation of the target A′ is toward the sky, the UAV 500 will fly according to a position pointed by the target A′.

In some embodiments, the user can adjust the preset reference height. For example, when the user controls the UAV indoors, the preset reference height can be adjusted to be less than or equal to an indoor height. When the user controls the UAV outdoors, the preset reference height can be adjusted to a relatively large value.

In some embodiments, after the user selects the target and the UAV begins to fly, the user can drag the target as needed or reset the target. After the new target is determined, the UAV can re-execute the processes shown in FIG. 4.

In some embodiments, the user can select at least two targets and the UAV 500 can automatically determine whether the flight path including the at least two targets is feasible. If the flight path is feasible, the UAV 500 will follow the calculated flight path. If the flight path is not feasible, the UAV 500 may return a failure prompt to the user. For example, warning information (e.g., path planning failure or the like) may be displayed on the input-output device 148.

According to the disclosure, the UAV control method can control the UAV to fly to a place above a position of the ground corresponding to the target and hover directly above the target, according to the inputted position of the target in the image and the first height. As such, an autonomous flight of the UAV, e.g., an autonomously hovering, can be realized, and the flight of the UAV can be precisely controlled.

It can be appreciated that the above-described UAV control methods are merely for better understanding of the present disclosure. Those skilled in the art will be appreciated that any modification or equivalents to the disclosed embodiments are intended to be encompassed within the scope of the present disclosure. For example, the above-described UAV control method can be applied indoors as well as outdoors.

It is intended that the disclosed embodiments are considered as exemplary only and not to limit the scope of the disclosure. Those skilled in the art will be appreciated that any equivalent structure or equivalent process transformation on the basis of the contents of the specification and drawings of the present disclosure directly or indirectly applied in other related technical fields are intended to be encompassed within the scope of the present disclosure.

What is claimed is:

1. A method for controlling an unmanned aerial vehicle (UAV), comprising:
receiving a position of a target in an image;
obtaining a flight height of the UAV relative to a ground; and
controlling a flight of the UAV according at least to the position of the target in the image and the flight height.

2. The method of claim 1, wherein controlling the flight of the UAV comprises:
obtaining a preset reference height; and
controlling the flight of the UAV according to the preset reference height, the flight height, and the position of the target in the image.

3. The method of claim 2, wherein controlling the flight of the UAV further comprises:
calculating a corresponding position of the target on the ground according to the position of the target in the image;
analyzing the flight height according to the preset reference height;
controlling the UAV to fly to the preset reference height; and
controlling the UAV to fly at the preset reference height.

4. The method of claim 2, wherein controlling the flight of the UAV further comprises:
calculating a corresponding position of the target on the ground according to the position of the target in the image;
analyzing the flight height according to the preset reference height; and
controlling the UAV to fly at the flight height toward the corresponding position of the target on the ground and to hover over the corresponding position.

5. The method of claim 1, wherein obtaining the flight height comprises obtaining the flight height through a sensor.

6. The method of claim 5, wherein the sensor comprises at least one of an ultrasonic sensor, a time-of-flight (TOF) sensor, an infrared sensor, a microwave sensor, or a proximity sensor.

7. An unmanned aerial vehicle (UAV), comprising:
a sensor configured to obtain a flight height of the UAV relative to a ground; and
a processor configured to:
receive a position of a target in an image; and
control a flight of the UAV according at least to the position of the target in the image and the flight height.

8. The UAV of claim 7, further comprising:
a storage device storing a preset reference height.

9. The UAV of claim 8, wherein the processor is further configured to:
obtain the preset reference height; and
control the flight of the UAV according to the preset reference height, the flight height, and the position of the target in the image.

10. The UAV of claim 9, wherein the processor is further configured to:
calculate a corresponding position of the target on the ground according to the position of the target in the image;
analyze the flight height according to the preset reference height;
control the UAV to fly to the preset reference height; and
control the UAV to fly at the preset reference height.

11. The UAV of claim 9, wherein the processor is further configured to:
calculate a corresponding position of the target on the ground according to the position of the target in the image;
analyze the flight height according to the preset reference height; and
control the UAV to fly at the flight height toward the corresponding position of the target on the ground and to hover over the corresponding position.

12. The UAV of claim 7, wherein the sensor comprises at least one of an ultrasonic sensor, a time-of-flight (TOF) sensor, an infrared sensor, a microwave sensor, or a proximity sensor.
